(19) United States
(12) Patent Application Publication
(10) Pub. No.: US 2026/0148891 A1
(43) Pub. Date: May 28, 2026

(54) IGNITION COIL

(71) Applicant: DIAMOND&ZEBRA ELECTRIC MFG. CO., LTD., Osaka-shi, Osaka (JP)

(72) Inventors: Atsushi Shinohara, Osaka-shi (JP); Junichi TANDA, Osaka-shi (JP)

(73) Assignee: DIAMOND&ZEBRA ELECTRIC MFG. CO., LTD., Osaka-shi, Osaka (JP)

(21) Appl. No.: 19/120,949

(22) PCT Filed: Jan. 30, 2023
(86) PCT No.: PCT/JP2023/002813

§ 371 Date: Apr. 14, 2025

(30) Foreign Application Priority Data
Nov. 11, 2022 (JP) 2022-180792

(51) Int. Cl. H01F 38/12; H01F 27/29; H01F 27/40

(52) U.S. Cl. CPC H01F 38/12; H01F 27/29; H01F 27/40; H01F 2038/122

(57) ABSTRACT

An ignition coil 2 according to one embodiment includes a primary coil 16, a secondary coil 18, a resistor 28 shaped as a rod, and a high-voltage terminal 22 electrically connecting an output of the secondary coil 18 to the resistor 28. The high-voltage terminal 22 includes a cap 26 having an inner circumferential surface 50 and an internal bottom surface 52 and covering an end of the resistor 28. The ignition coil 2 further includes one or more air passages 55 leading from the internal bottom surface 52 to an external environment.

### TECHNICAL FIELD

The present specification discloses an ignition coil of an internal combustion engine.

### BACKGROUND ART

A typical ignition coil includes: primary and secondary coils for generating a high voltage; a resistor for reducing electrical noise; and a high-voltage terminal electrically connecting the secondary coil to the resistor. The high voltage from the secondary coil is applied to the resistor via the high-voltage terminal and applied via the resistor to an ignition plug located in a combustion chamber of a high-compression internal combustion engine. This voltage application induces electric discharge of the ignition plug, from which a spark is emitted to ignite the fuel of the internal combustion engine.

A resistor is usually shaped as a rod. In some cases, a high-voltage terminal having a cap portion for connection to the resistor is used to ensure the connection between the high-voltage terminal and the resistor. An example of an ignition coil including such a high-voltage terminal is disclosed in Japanese Laid-Open Patent Application Publication No. 2019-96788.

### CITATION LIST

### Patent Literature

PTL 1: Japanese Laid-Open Patent Application Publication No. 2019-96788

### SUMMARY OF INVENTION

### Technical Problem

In assembly of the ignition coil, the cap portion of the high-voltage terminal is fitted on the resistor. The fitting of the cap portion often requires a large force due to air remaining between the end of the resistor and the cap portion. This makes it difficult to attach the cap portion to the resistor and could cause damage to an upper portion of the resistor. There is a demand for an ignition coil in which a high-voltage terminal and a resistor can be easily connected to each other.

The present inventors aim to provide an ignition coil in which a high-voltage terminal and a resistor can be easily connected to each other.

### Solution to Problem

An ignition coil according to one embodiment includes a primary coil, a secondary coil, a resistor shaped as a rod, and a high-voltage terminal electrically connecting an output of the secondary coil to the resistor. The high-voltage terminal includes a cap having an inner circumferential surface and an internal bottom surface and covering an end of the resistor. The ignition coil further includes one or more air passages leading from the internal bottom surface to an external environment.

### Advantageous Effects of Invention

The ignition coil includes the air passage(s) leading from the internal bottom surface of the cap to an external environment. When the cap is fitted on the resistor, air remaining between the end of the resistor and the cap is discharged to the external environment through the air passage(s). In the ignition coil, the cap can be fitted on the resistor without having to apply any large force. In the ignition coil, the high-voltage terminal and the resistor can be easily connected to each other.

### BRIEF DESCRIPTION OF DRAWINGS

FIG. 1 is a cross-sectional view showing an ignition coil according to one embodiment.

FIG. 2A is a perspective view showing a cap of a high-voltage terminal and a resistor in the ignition coil of FIG. 1, and FIG. 2B is an exploded view of FIG. 2A.

FIG. 3 is a perspective view showing the cap of FIG. 2A.

FIG. 4A is a cross-sectional view taken along the line IVa-IVa of FIG. 3, and FIG. 4B is a cross-sectional view showing the cap of FIG. 4A with the resistor inserted therein.

FIG. 5 is a cross-sectional view taken along the line V-V of FIG. 4B.

FIG. 6A is a cross-sectional view showing a cap and a resistor of an ignition coil according to another embodiment, and FIG. 6B is a cross-sectional view showing a cap and a resistor of an ignition coil according to yet another embodiment.

FIG. 7 is a cross-sectional view showing a cap and a resistor of an ignition coil according to yet another embodiment.

FIG. 8A is a perspective view showing a cap of an ignition coil according to yet another embodiment, and FIG. 8B is a bottom view of the cap of FIG. 8A.

FIG. 9 is a bottom view showing a cap of an ignition coil according to yet another embodiment.

FIG. 10 is a cross-sectional view showing a cap and a resistor of an ignition coil according to yet another embodiment.

FIG. 11 is a bottom view of the cap of FIG. 10.

### DESCRIPTION OF EMBODIMENTS

The following will describe the present invention in detail based on preferred embodiments with appropriate reference to the drawings.

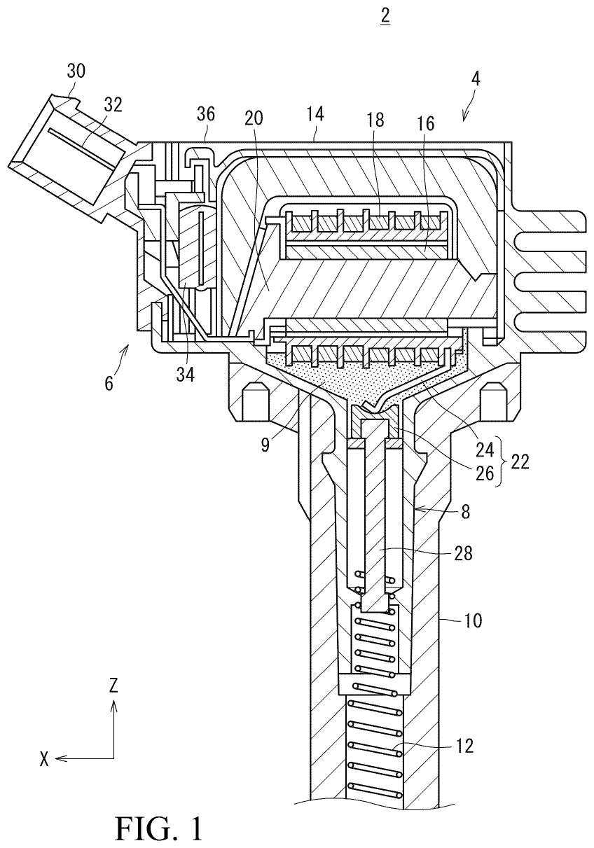

FIG. 1 is a cross-sectional view showing an ignition coil 2 according to one embodiment. In FIG. 1, the arrow X represents the forward direction with respect to the ignition coil 2. The opposite direction is the rearward direction. The arrow Z represents the upward direction with respect to the ignition coil 2. The opposite direction is the downward direction. The ignition coil 2 is for use in an internal combustion engine. As shown in FIG. 1, the ignition coil 2 includes a coil assembly 4, a connector portion 6, and an output portion 8. The ignition coil 2 further includes a filler 9 made of a thermosetting resin, and the filler 9 fills gaps present in the ignition coil 2. FIG. 1 further shows a plug boot 10 and a spring 12 mounted to the ignition coil 2.

The coil assembly 4 includes a case 14, a primary coil 16, a secondary coil 18, an iron core 20, and a high-voltage terminal 22. The primary coil 16, the secondary coil 18, the iron core 20, and the high-voltage terminal 22 are enclosed in the case 14. The primary coil 16 is formed by winding a wire around the iron core 20, and the secondary coil 18 is formed by winding a wire around the outside of the primary coil 16. The number of wire turns in the secondary coil 18 is much greater than the number of wire turns in the primary coil 16. Thus, a change in the current flowing through the primary coil 16 generates a high voltage in the secondary coil 18.

The high-voltage terminal 22 is electrically connected to an output terminal of the secondary coil 18 and electrically connected to a resistor 28 of the output portion 8 described later. The output from the secondary coil 18 is applied to the resistor 28 via the high-voltage terminal 22. The high-voltage terminal 22 includes an arm 24 and a cap 26. The arm 24 has one end connected to the output terminal of the secondary coil 18 and the other end connected to the cap 26. The high-voltage terminal 22 is made of a metal having high electrical conductivity. Preferred examples of the material of the high-voltage terminal 22 include aluminum alloys and copper.

As shown in FIG. 1, the connector portion 6 is located in front of the coil assembly 4. The connector portion 6 includes a tubular portion 30, external terminals 32, an ignitor 34, and a case 36. The case 36 of the connector portion 6 is integral with the case 14 of the coil assembly 4.

The tubular portion 30 is shaped as a tube having a front opening. The plurality of external terminals 32 are located inside the tubular portion 30. Some of the external terminals 32 are connected to the ignitor 34. The ignitor 34 is located behind the tubular portion 30. The ignitor 34 is a switch that controls whether to permit or block a current flow to the primary coil 16 in response to a signal from an external entity. The case 36 surrounds the ignitor 34.

As shown in FIG. 1, the output portion 8 is located below the coil assembly 4. The output portion 8 is shaped as a tube extending downward from the coil assembly 4. The output portion 8 includes in its interior a resistor 28 shaped as a rod. In the embodiment of FIG. 1, the plug boot 10 and the spring 12 are mounted to the output portion 8. A high voltage generated in the secondary coil 18 is input to the resistor 28 via the high-voltage terminal 22 and delivered from the resistor 28 to the spring 12. With the ignition coil 2 mounted to an internal combustion engine, the spring 12 is connected to an ignition plug of the internal combustion engine.

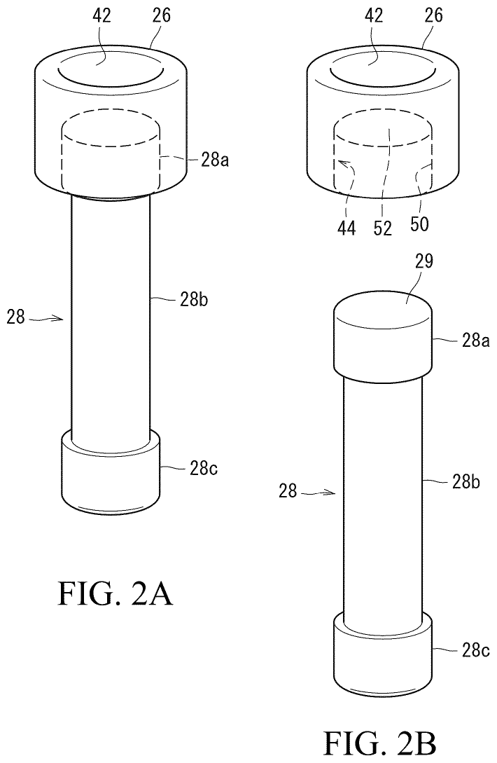

FIG. 2A is an enlarged perspective view showing the resistor 28 and the cap 26 of the high-voltage terminal 22, and FIG. 2B is an exploded view of FIG. 2A. The resistor 28 is shaped as a rod. In this embodiment, the resistor 28 is shaped as a circular cylinder. The resistor 28 includes an upper portion 28a, a middle portion 28b, and a lower portion 28c. The outer diameters of the upper and lower portions 28a and 28c are slightly greater than the outer diameter of the middle portion 28b. As shown in FIG. 1, with the ignition coil 2 mounted to an internal combustion engine, the lower portion 28c of the resistor 28 is in contact with the spring 12. Although not shown, the lower end of the spring 12 is connected to an ignition plug of the internal combustion engine. The cap 26 is fitted on the upper portion 28a of the resistor 28. The resistor 28 has an electrical resistance and an inductance suitable for reducing electrical noise (conduction noise or radiation noise) caused by electric discharge of the ignition plug.

The outer diameter of the resistor 28 may be constant from the upper end of the resistor 28 to the lower end of the resistor 28. The resistor 28 need not be shaped as a circular cylinder. For example, the resistor 28 may be shaped as a prism.

As shown in FIGS. 2A and 2B, the cap 26 is shaped as a cylindrical tube. The upper surface of the cap 26 includes a depression 42. As shown in FIG. 1, the lower portion of the arm 24 includes a downwardly convex bend, and this bend is located inside the depression 42 of the cap 26. Thus, the cap 26 and the arm 24 are connected to each other.

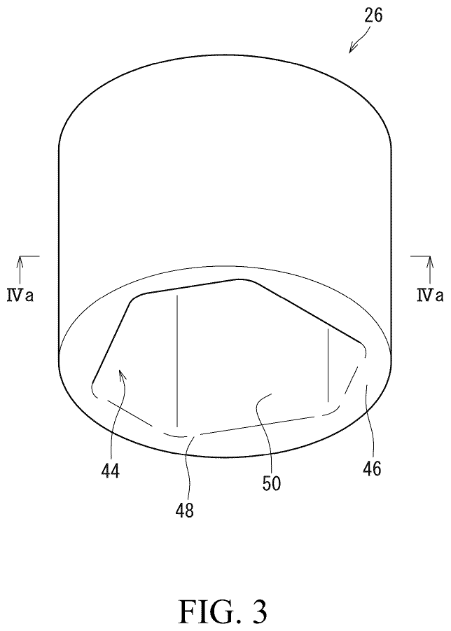

FIG. 3 is a bottom perspective view of the cap 26. As shown in FIGS. 2B and 3, the cap 26 includes an internal cavity 44. The cap 26 includes a bottom surface 46, on which there is an opening 48 of the cavity 44. The cavity 44 defines an inner circumferential surface 50 and an internal bottom surface 52 of the cap 26. The inner circumferential surface 50 extends in the upward/downward direction (the direction in which the resistor 28 extends). The corners between the bottom surface 46 and the inner circumferential surface 50 of the cap 26 are rounded. As shown in FIG. 2A, the upper portion 28a of the resistor 28 is fitted in the cavity 44. The upper surface 29 of the resistor 28 is in contact with the internal bottom surface 52 of the cap 26. The cap 26 covers one end of the resistor 28. In this embodiment, the cap 26 covers the upper portion 28a of the resistor 28. Thus, the high-voltage terminal 22 and the resistor 28 are electrically connected to each other.

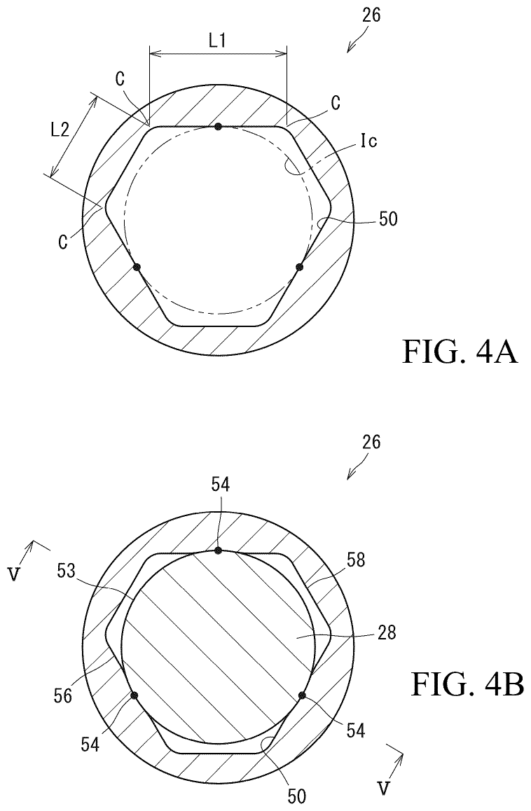

FIG. 4A is a cross-sectional view taken along the line IVa-IVa of FIG. 3. This is a cross-section of the cap 26 without the resistor 28 inserted in the cavity 44, and the cross-section is perpendicular to the direction in which the resistor 28 extends. In FIG. 4A, the dashed-double dotted line represents an inscribed circle Ic of the inner circumferential surface 50. In the cross-section, the inner circumferential surface 50 presents a substantially polygonal shape. In this embodiment, the inner circumferential surface 50 presents an approximately hexagonal shape. In the cross-section, the inner circumferential surface 50 is defined by six sides. In this embodiment, the inner circumferential surface 50 of the cap 26 and the inscribed circle Ic are in contact at three points.

FIG. 4B shows a cross-section of the cap 26 with the resistor 28 inserted in the cavity 44. The cross-section is perpendicular to the direction in which the resistor 28 extends and taken at a location where the resistor 28 is covered by the cap 26. This figure shows the cap 26 of FIG. 4A with the resistor 28 inserted therein. In this embodiment, the outer circumferential surface 53 of the resistor 28 is slightly greater than the inscribed circle Ic shown in FIG. 4A. Thus, the inner circumferential surface 50 of the cap 26 of FIG. 4B is slightly deformed as compared to the inner circumferential surface 50 of FIG. 4A. As shown in FIG. 4B, the inner circumferential surface 50 of the cap 26 and the outer circumferential surface 53 of the resistor 28 are substantially in contact at a plurality of points 54. In this embodiment, the inner circumferential surface 50 of the cap 26 and the outer circumferential surface 53 of the resistor 28 are in contact at three points 54. This contact fixes the cap 26 to the resistor 28. In other words, the points 54 at which the cap 26 and the resistor 28 are in contact are located such that the cap 26 can be fixed to the resistor 28.

In the cross-section shown in FIG. 4B, the inner circumferential surface 50 includes sides that are in contact with the outer circumferential surface 53 of the resistor 28 and sides that are not in contact with the outer circumferential surface 53 of the resistor 28. Those sides of the inner circumferential surface 50 which are in contact with the outer circumferential surface 53 of the resistor 28 are referred to as contact sides 56. The other sides of the inner circumferential surface 50 which are not in contact with the outer circumferential surface 53 of the resistor 28 are referred to as non-contact sides 58. In this embodiment, there are three contact sides 56 and three non-contact sides 58. Each of the contact sides 56 is located between two of the non-contact sides 58. The contact and non-contact sides 56 and 58 alternate.

In the present specification, the statement that the inner circumferential surface 50 of the cap 26 and the outer circumferential surface 53 of the resistor 28 are “in contact at a point” means that the contact portion over which the inner circumferential surface 50 of the cap 26 and the outer circumferential surface 53 of the resistor 28 are in contact has a length, as measured in the circumferential direction of the resistor 28, of 5% or less of the outer circumference of the resistor 28.

In this embodiment, the three contact sides 56 have substantially the same length. The three contact sides 56 may have different lengths. In this embodiment, the three non-contact sides 58 have substantially the same length. The three non-contact sides 58 may have different lengths.

It is not necessary that each contact side 56 be located between two non-contact sides 58. A plurality of contact sides 56 may be continuous with each other. There may be no non-contact sides 58. There may be a plurality of non-contact sides 58 between two contact sides 56.

As described later, the number of the points 54 at which the inner circumferential surface 50 of the cap 26 and the outer circumferential surface 53 of the resistor 28 are in contact need not be three. The number of the points 54 at which the inner circumferential surface 50 of the cap 26 and the outer circumferential surface 53 of the resistor 28 are in contact may be from three to six.

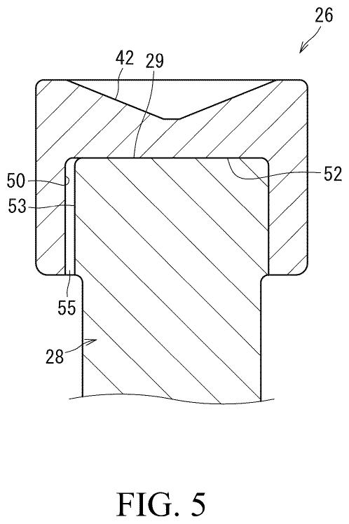

FIG. 5 is a cross-sectional view taken along the line V-V of FIG. 4B. As shown in FIG. 5, there is a gap 55 between the inner circumferential surface 50 and the outer circumferential surface 53 at a location other than any location where the inner circumferential surface 50 and the outer circumferential surface 53 are in contact at a point. The gap 55 extends from the internal bottom surface 52 to an external environment. When the cap 26 is fitted on the resistor 28, air present between the internal bottom surface 52 and the upper surface 29 of the resistor 28 is discharged to the external environment through the gap 55. The gap 55 is an air passage 55 leading from the internal bottom surface 52 to the external environment. In this embodiment, where the inner circumferential surface 50 and the outer circumferential surface 53 are in contact at the three points 54, there are three air passages 55 each of which is located between two of the points 54.

The following will describe the workings and effects of the present embodiment.

In the ignition coil 2, there are the gaps 55 between the inner circumferential surface 50 of the cap 26 and the outer circumferential surface 53 of the resistor 28. When the cap 26 is fitted on the resistor 28, air remaining between the upper surface 29 of the resistor 28 and the internal bottom surface 52 of the cap 26 is discharged to the external environment through the gaps 55. The gaps 55 are air passages 55 leading from the internal bottom surface 52 of the cap 26 to the external environment. In the ignition coil 2, the cap 26 can be fitted on the resistor 28 without having to apply any large force. In the ignition coil 2, the high-voltage terminal 22 and the resistor 28 can be easily connected to each other. The upper portion 28a of the resistor 28 is prevented from being damaged when the cap 26 is fitted on the resistor 28.

In general, the outer diameter or outer shape of resistors could vary from product to product. For example, a resistor shaped as a circular cylinder could have an outer shape deviating from a true circle. Such a deviation could make it difficult to attach a cap to the resistor. In some cases, the cap cannot be fitted to a given point on the resistor or the upper portion of the resistor could be damaged. There is a demand for an ignition coil in which a high-voltage terminal and a resistor can be easily and reliably connected to each other.

In the ignition coil 2, the outer circumferential surface 53 of the resistor 28 and the inner circumferential surface 50 of the cap 26 of the high-voltage terminal 22 are in contact at the three points 54 in a cross-section perpendicular to the direction in which the resistor 28 extends. Since the outer circumferential surface 53 of the resistor 28 and the inner circumferential surface 50 of the cap 26 of the high-voltage terminal 22 are in point contact, the contact area between the resistor 28 and the cap 26 is small. Additionally, the fact that the outer circumferential surface 53 of the resistor 28 and the inner circumferential surface 50 of the cap 26 of the high-voltage terminal 22 are in point contact leads to a small area of that portion of the inner circumferential surface 50 which is to be deformed when the outer diameter or shape of the resistor 28 has a deviation from a given outer diameter or shape. The inner circumferential surface 50 of the cap 26 is flexibly deformable. In the ignition coil 2, the high-voltage terminal 22 and the resistor 28 can be easily connected to each other even when the outer diameter or shape of the resistor 28 has a deviation from a given outer diameter or shape. Furthermore, the cap 26 can be securely fixed to the resistor 28 since the inner circumferential surface 50 of the cap 26 are in contact with the resistor 28 at the three points 54. In the ignition coil 2, the high-voltage terminal 22 and the resistor 28 can be reliably connected to each other.

In this embodiment, the inner circumferential surface 50 includes the contact sides 56 and the non-contact sides 58. The shape of the inner circumferential surface 50 can be closer to a circle than when the inner circumferential surface 50 includes only the contact sides 56. Thus, the location-dependent variation in the thickness between the inner circumferential surface 50 of the cap 26 and the outer circumferential surface of the cap 26 can be reduced. This contributes to high strength of the cap 26.

In this embodiment, each contact side 56 is located between two of the non-contact sides 58. The two non-contact sides 58 are respectively adjacent to the opposite ends of the contact side 56. This allows the inner circumferential surface 50 of the cap 26 to flexibly deform upon contact of the resistor 28 with the contact sides 56. In the ignition coil 2, the high-voltage terminal 22 and the resistor 28 can be easily connected to each other.

In this embodiment, as shown in FIGS. 4A and 4B, the corners between the contact sides 56 and the non-contact sides 58 are rounded. Each of the reference signs C of FIG. 4A indicates an intersection point at which an extension of a corresponding one of the contact sides 56 and an extension of a corresponding one of the non-contact sides 58 would intersect if the corner between the contact side 56 and the non-contact side 58 was not rounded. If the corner between each contact side 56 and an adjacent one of the non-contact sides 58 was not rounded, the contact side 56 and the adjacent non-contact side 58 would form an angle at the intersection point. In the present specification, the length of each contact side 56 or each non-contact side 58 is defined as the distance between two intersection points C located at the opposite ends of the side 56 or 58. The double-headed arrow L1 represents the length of a contact side 56. The double-headed arrow L2 represents the length of a non-contact side 58 adjacent to the contact side 56.

The length L1 of the contact side 56 is preferably greater than the length L2 of the non-contact side 58 adjacent to the contact side 56. When the length L1 is greater than the length L2, the inner circumferential surface 50 of the cap 26 can flexibly deform upon contact of the resistor 28 with the contact side 56. In the ignition coil 2, the high-voltage terminal 22 and the resistor 28 can be easily connected to each other. From this viewpoint, each of the contact sides 56 is more preferably longer than all of the non-contact sides 58.

The length L1 is preferably 1.5 or more times the length L2. When the length L1 is 1.5 or more times the length L2, the inner circumferential surface 50 of the cap 26 can flexibly deform upon contact of the resistor 28 with the contact side 56. In the ignition coil 2, the high-voltage terminal 22 and the resistor 28 can be easily connected to each other. The length L1 is preferably 2.5 or less times the length L2. When the length L1 is 2.5 or less times the length L2, the shape of the inner circumferential surface 50 can be close to a circle. Thus, the location-dependent variation in the thickness between the inner circumferential surface 50 and the outer circumferential surface 53 of the cap 26 can be reduced. This contributes to high strength of the cap 26.

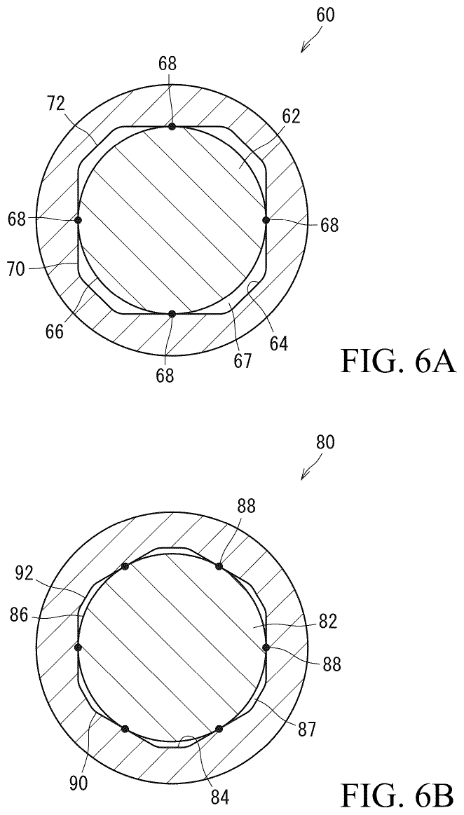

FIG. 6A is a cross-sectional view showing a cap 60 of a high-voltage terminal and a resistor 62 in an ignition coil according to another embodiment. This cross-section is perpendicular to the direction in which the resistor 62 extends and taken at a location where the resistor 62 is covered by the cap 60. This ignition coil is the same as the ignition coil 2 of FIG. 1, except for the cap 60.

In this embodiment, as shown in FIG. 6A, the inner circumferential surface 64 of the cap 60 presents an approximately octagonal shape. In this embodiment, the inner circumferential surface 64 is defined by eight sides. As shown in FIG. 6A, the inner circumferential surface 64 of the cap 60 and the outer circumferential surface 66 of the resistor 62 are in contact at a plurality of points 68. In this embodiment, the inner circumferential surface 64 of the cap 60 and the outer circumferential surface 66 of the resistor 62 are in contact at four points 68. This contact fixes the cap 60 to the resistor 62. In this embodiment, there are four contact sides 70 and four non-contact sides 72. Each of the contact sides 70 is located between two of the non-contact sides 72. The contact and non-contact sides 70 and 72 alternate. There are gaps 67 between the inner circumferential surface 64 and the outer circumferential surface 66. The gaps 67 are air passages 67 leading from the internal bottom surface of the cap 60 to an external environment.

In the ignition coil, there are the gaps 67 between the inner circumferential surface 64 of the cap 60 and the outer circumferential surface 66 of the resistor 62. When the cap 60 is fitted on the resistor 62, air remaining between the upper surface of the resistor 62 and the internal bottom surface 52 of the cap 60 is discharged to the external environment through the gaps 67. In the ignition coil, the cap 60 can be fitted on the resistor 62 without having to apply any large force. In the ignition coil, the high-voltage terminal and the resistor 62 can be easily connected to each other. The upper portion of the resistor 62 is prevented from being damaged when the cap 60 is fitted on the resistor 62.

In the ignition coil, the outer circumferential surface 66 of the resistor 62 and the inner circumferential surface 64 of the cap 60 of the high-voltage terminal are in contact at the four points 68 in a cross-section perpendicular to the direction in which the resistor 62 extends. Since the outer circumferential surface 66 of the resistor 62 and the inner circumferential surface 64 of the cap 60 of the high-voltage terminal are in point contact, the contact area between the resistor 62 and the cap 60 is small. Additionally, the fact that the outer circumferential surface 66 of the resistor 62 and the inner circumferential surface 64 of the cap 60 of the high-voltage terminal are in point contact allows for flexible deformation of the inner circumferential surface 64 of the cap 60. In the ignition coil, the high-voltage terminal and the resistor 62 can be easily connected to each other even when the outer diameter or shape of the resistor 62 has a deviation from a given outer diameter or shape. Furthermore, the cap 60 can be securely fixed to the resistor 62 since the inner circumferential surface 64 of the cap 60 are in contact with the resistor 62 at the four points 68. In the ignition coil, the high-voltage terminal and the resistor 62 can be reliably connected to each other.

FIG. 6B is a cross-sectional view showing a cap 80 of a high-voltage terminal and a resistor 82 in an ignition coil according to yet another embodiment. This cross-section is perpendicular to the direction in which the resistor 82 extends and taken at a location where the resistor 82 is covered by the cap 80. This ignition coil is the same as the ignition coil 2 of FIG. 1, except for the cap 80.

In this embodiment, as shown in FIG. 6B, the inner circumferential surface 84 of the cap 80 presents an approximately dodecagonal shape. In this embodiment, the inner circumferential surface 84 is defined by 12 sides. In this embodiment, as shown in FIG. 6B, the inner circumferential surface 84 of the cap 80 and the outer circumferential surface 86 of the resistor 82 are in contact at six points 88. This contact fixes the cap 80 to the resistor 82. In this embodiment, there are six contact sides 90 and six non-contact sides 92. Each of the contact sides 90 is located between two of the non-contact sides 92. The contact and non-contact sides 90 and 92 alternate. There are gaps 87 between the inner circumferential surface 84 and the outer circumferential surface 86. The gaps 87 are air passages 87 leading from the internal bottom surface of the cap 80 to an external environment.

Although not shown, an ignition coil according to yet another embodiment has an inner circumferential surface that presents an approximately decagonal shape. In this embodiment, the inner circumferential surface is defined by 10 sides. In this embodiment, the inner circumferential surface of the cap and the outer circumferential surface of the resistor are in contact at five points. This contact fixes the cap to the resistor. In this embodiment, there are five contact sides and five non-contact sides. Each of the contact sides is located between two of the non-contact sides. The contact and non-contact sides alternate. There are gaps between the inner circumferential surface and the outer circumferential surface. The gaps are air passages leading from the internal bottom surface of the cap to an external environment.

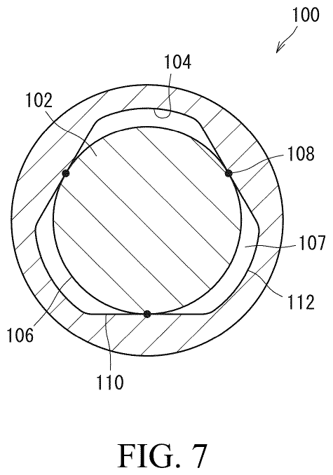

FIG. 7 is a cross-sectional view showing a cap 100 of a high-voltage terminal and a resistor 102 in an ignition coil according to yet another embodiment. This cross-section is perpendicular to the direction in which the resistor 102 extends and taken at a location where the resistor 102 is covered by the cap 100. This ignition coil is the same as the ignition coil 2 of FIG. 1, except for the cap 100.

In this embodiment, as shown in FIG. 7, the inner circumferential surface 104 of the cap 100 and the outer circumferential surface 106 of the resistor 102 are in contact at three points 108. In this embodiment, there are three contact sides 110 and three non-contact sides 112. Each of the contact sides 110 is located between two of the non-contact sides 112. The contact and non-contact sides 110 and 112 alternate. There are gaps 107 between the inner circumferential surface 104 and the outer circumferential surface 106. In this embodiment, as shown in FIG. 7, the non-contact sides 112 are curved. The non-contact sides 112 are arc-shaped.

In the ignition coil, the outer circumferential surface 106 of the resistor 102 and the inner circumferential surface 104 of the cap 100 of the high-voltage terminal are in contact at the three points 108 in a cross-section perpendicular to the direction in which the resistor 102 extends. Furthermore, in this embodiment where the non-contact sides 112 are arc-shaped, the thickness between the outer circumferential surface 106 and the inner circumferential surface 104 of the cap 100 can be reduced in the regions over which the arc-shaped non-contact sides 112 extend. These features allow for flexible deformation of the inner circumferential surface 104 of the cap 100. In the ignition coil, the high-voltage terminal and the resistor 102 can be easily connected to each other even when the outer diameter or shape of the resistor 102 has a deviation from a given outer diameter or shape. Furthermore, the cap 100 can be securely fixed to the resistor 102 since the inner circumferential surface 104 of the cap 100 are in contact with the resistor 102 at the three points 108. In the ignition coil, the high-voltage terminal and the resistor 102 can be reliably connected to each other.

The shape of the cap of the ignition coil is not limited to those in the embodiments described above. For example, the contact sides may be curved. The cap may have any shape insofar as the outer circumferential surface of the resistor and the inner circumferential surface of the cap of the high-voltage terminal are in contact at three to six points.

In terms of easier connection of the high-voltage terminal and the resistor, the number of the points at which the outer circumferential surface of the resistor and the inner circumferential surface of the cap of the high-voltage terminal are in contact is more preferably five or less, more preferably four or less, and most preferably three.

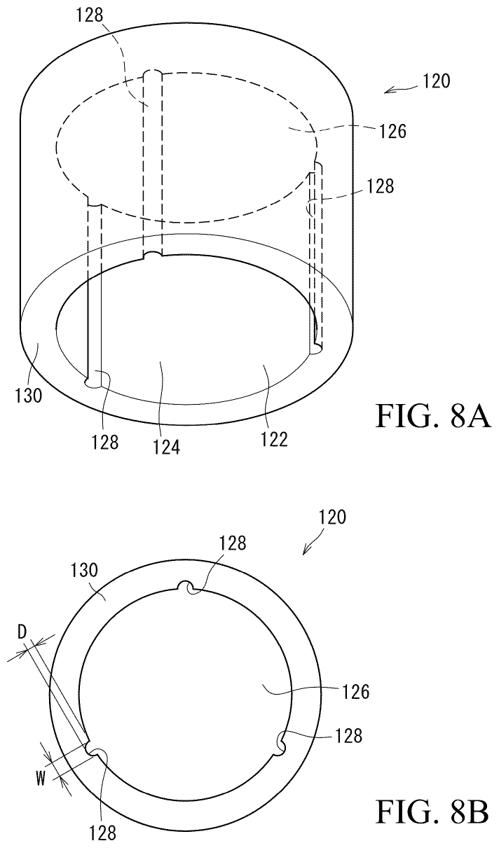

FIG. 8A is a bottom perspective view of a cap 120 of a high-voltage terminal of an ignition coil according to yet another embodiment. FIG. 8B is a bottom view of the cap 120 of FIG. 8A. This ignition coil is the same as the ignition coil 2 of FIG. 1, except for the cap 120.

As shown in FIG. 8A, the cap 120 includes an internal cavity 122. The cavity 122 defines an inner circumferential surface 124 and an internal bottom surface 126 of the cap 120. The inner circumferential surface 124 extends in the upward/downward direction (the direction in which the resistor extends). As shown in FIG. 8A, the inner circumferential surface 124 of the cap 120 includes grooves 128. In the bottom view, the inner circumferential surface 124, exclusive of the grooves 128, is substantially circular. The upper portion of the resistor is fitted in the cavity 122. The inner circumferential surface 124 comes into contact with the outer circumferential surface of the resistor. The cap 120 covers one end of the resistor. Thus, the high-voltage terminal and the resistor are electrically connected to each other.

In this embodiment, as shown in FIG. 8A, the inner circumferential surface 124 includes three grooves 128. As shown in FIG. 8B, the three grooves 128 are arranged substantially at regular intervals. Each of the grooves 128 has one end at the internal bottom surface 126 and the other end at the bottom surface 130. When the cap 120 is fitted on the resistor, air present between the internal bottom surface 126 and the upper surface of the resistor is discharged to an external environment through the grooves 128. The grooves 128 are air passages 128 leading from the internal bottom surface 126 to the external environment.

In the ignition coil, there are the grooves 128 leading from the internal bottom surface 126 of the cap 120 to the external environment. When the cap 120 is fitted on the resistor, air remaining between the upper surface of the resistor and the internal bottom surface 126 of the cap 120 is discharged to the external environment through the grooves 128. In the ignition coil, the cap 120 can be fitted on the resistor without having to apply any large force. In the ignition coil, the high-voltage terminal and the resistor can be easily connected to each other. The upper portion of the resistor is prevented from being damaged when the cap 120 is fitted on the resistor.

In FIG. 8B, the double-headed arrow W represents the width of each groove 128. In terms of effectively discharging air present between the internal bottom surface 126 and the upper surface of the resistor when fitting the cap 120 on the resistor, the width W is preferably 0.5 mm or more, more preferably 1.0 mm or more, and even more preferably 2.0 mm or more. In terms of easy machining, the width W is preferably 5 mm or less.

In FIG. 8B, the double-headed arrow D represents the depth of each groove 128. In terms of effectively discharging air present between the internal bottom surface 126 and the upper surface of the resistor when fitting the cap 120 on the resistor, the depth D is preferably 0.5 mm or more, more preferably 1.0 mm or more, and even more preferably 1.2 mm or more. In terms of easy machining, the depth D is preferably 3 mm or less.

The three grooves 128 are preferably arranged at regular intervals. In this case, air present between the internal bottom surface 126 and the upper surface of the resistor can be discharged evenly through the grooves 128 when the cap 120 is fitted on the resistor. In the ignition coil, the high-voltage terminal and the resistor can be easily connected to each other.

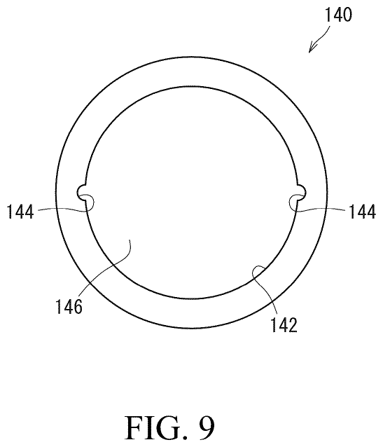

FIG. 9 is a bottom view showing a cap 140 of a high-voltage terminal of an ignition coil according to yet another embodiment. In the ignition coil, the inner circumferential surface 142 of the cap 140 includes grooves 144. In this embodiment, there are two grooves 144. This ignition coil is the same as the ignition coil of FIG. 8, except for the number of the grooves 144.

In this embodiment, the two grooves 144 face each other. Thus, air present between the internal bottom surface 146 and the upper surface of the resistor can be discharged evenly through the grooves 144 when the cap 140 is fitted on the resistor. In the ignition coil, the high-voltage terminal and the resistor can be easily connected to each other.

The number of the grooves 144 may be four or more, or there may be only one groove 144. In terms of effective discharge of air remaining between the upper surface of the resistor and the internal bottom surface 146 of the cap 140, the number of the grooves 144 is preferably two or more. In terms of easy machining, the number of the grooves 144 is preferably six or less, more preferably five or less, and even more preferably four or less.

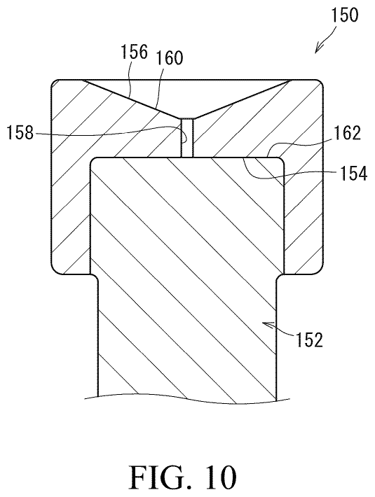

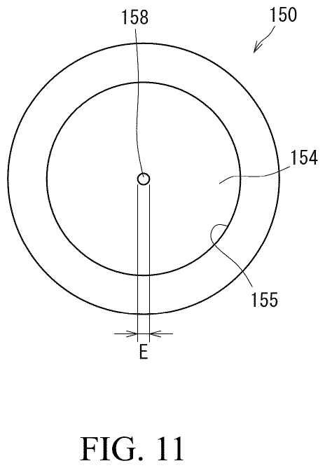

FIG. 10 is a cross-sectional view showing a cap 150 of a high-voltage terminal and a resistor 152 in an ignition coil according to yet another embodiment. FIG. 10 depicts a cross-section taken along a plane parallel to the direction in which the high-voltage terminal extends. FIG. 11 is a bottom view showing the cap 150 of FIG. 10. This ignition coil is the same as the ignition coil 2 of FIG. 1, except for the cap 150.

As shown in FIG. 10, the cap 150 includes a hole 158 extending from an internal bottom surface 154 of the cap 150 to an upper surface 156 of the cap 150. In this embodiment, as shown in FIG. 10, one of the openings of the hole 158 is located at the bottom of a depression 160 of the upper surface 156. As shown in FIG. 11, the other opening of the hole 158 is located at the center of the internal bottom surface 154. In the bottom view, the inner circumferential surface 155 of the cap 150 is substantially circular. The inner circumferential surface 155 is in contact with the outer circumferential surface of the resistor. When the cap 150 is fitted on the resistor 152, air present between the internal bottom surface 154 and the upper surface 162 of the resistor 152 is discharged to an external environment through the hole 158. The hole 158 is an air passage 158 leading from the internal bottom surface 154 to the external environment.

In the ignition coil, there is the hole 158 leading from the internal bottom surface 154 of the cap 150 to the external environment. When the cap 150 is fitted on the resistor 152, air remaining between the upper surface 162 of the resistor 152 and the internal bottom surface 154 of the cap 150 is discharged to the external environment through the hole 158. In the ignition coil, the cap 150 can be fitted on the resistor 152 without having to apply any large force. In the ignition coil, the high-voltage terminal and the resistor 152 can be easily connected to each other. The upper portion of the resistor 152 is prevented from being damaged when the cap 150 is fitted on the resistor 152.

The other opening of the hole 158 is preferably located at the center of the internal bottom surface 154. In this case, air present between the internal bottom surface 154 and the upper surface 162 of the resistor 152 can be discharged evenly through the hole 158 when the cap 150 is fitted on the resistor 152. In the ignition coil, the high-voltage terminal and the resistor 152 can be easily connected to each other.

In FIG. 11, the double-headed arrow E represents the inner diameter of the hole 158. The inner diameter E is preferably 0.5 mm or more. When the inner diameter E is 0.5 mm or more, air remaining between the upper surface 162 of the resistor 152 and the internal bottom surface 154 of the cap 150 can be effectively discharged to the external environment through the hole 158. From this viewpoint, the inner diameter E is more preferably 1.0 mm or more.

As with the embodiment shown in FIG. 1, the bend of the arm is located inside the depression 160 of the upper surface 156 of the cap 150. The contact of the bend with the surface of the depression 160 ensures a desired contact area between the arm and the cap 150. If the inner diameter E of the hole 158 is more than 2.0 mm, the apex of the bend is more likely to enter the opening of the hole 158, and the contact area could be small. In terms of ensuring a desired contact area between the arm and the cap 150, the inner diameter E is preferably 2.0 mm or less.

The foregoing has described embodiments of an ignition coil having an air passage. The described embodiments are an ignition coil in which an outer circumferential surface of a resistor and an inner circumferential surface of a cap are in contact at points, an ignition coil in which an inner circumferential surface of a cap includes grooves, and an ignition coil in which a cap includes a hole extending from an internal bottom surface of the cap to an upper surface of the cap. An ignition coil may have these features in combination. For example, in an ignition coil according to yet another embodiment, an outer circumferential surface of a resistor and an inner circumferential surface of a cap may be in contact at points, and the cap may include a hole extending from an internal bottom surface of the cap to an upper surface of the cap. In an ignition coil according to yet another embodiment, an inner circumferential surface of a cap may include a groove, and the cap may include a hole extending from an internal bottom surface of the cap to an upper surface of the cap.

As described above, the present embodiments provide ignition coils in which a high-voltage terminal and a resistor can be easily connected to each other. This demonstrates the superiority of the present embodiments.

### DISCLOSED ITEMS

The following items disclose preferred embodiments.
[Item 1]
   An ignition coil for an internal combustion engine, the ignition coil including:
      a primary coil;
      a secondary coil;
      a resistor shaped as a rod; and
      a high-voltage terminal electrically connecting an output of the secondary coil to the resistor, wherein
      the high-voltage terminal includes a cap having an inner circumferential surface and an internal bottom surface and covering an end of the resistor, and
      the ignition coil further includes one or more air passages leading from the internal bottom surface to an external environment.
[Item 2]
   The ignition coil according to item 1, wherein
      an outer circumferential surface of the resistor and the inner circumferential surface are in contact at three to six points in a cross-section perpendicular to a direction in which the resistor extends and taken at a location where the resistor is covered by the cap, and
      one of the air passages is a gap between the outer circumferential surface and the inner circumferential surface.
[Item 3]
   The ignition coil according to item 2, wherein
      in the cross-section, the outer circumferential surface of the resistor and the inner circumferential surface of the cap are in contact at three points.
[Item 4]
   The ignition coil according to item 2 or 3, wherein
      in the cross-section
      the inner circumferential surface includes a plurality of contact sides each of which is in contact with the resistor at a point and a plurality of non-contact sides that are not in contact with the resistor, and
      each of the contact sides is located between two of the non-contact sides.
[Item 5]
   The ignition coil according to item 4, wherein
      each of the contact sides is longer than an adjacent one of the non-contact sides.
[Item 6]
   The ignition coil according to item 5, wherein each of the contact sides is 1.5 to 2.5 times longer than the adjacent one of the non-contact sides.
[Item 7]
   The ignition coil according to any one of items 2 to 6, wherein in the cross-section, an inner circumferential surface of the resistor is polygonal.
[Item 8]
   The ignition coil according to any one of items 1 to 7, wherein
      the inner circumferential surface of the cap includes one or more grooves each of which has one end at the internal bottom surface, and
      one of the air passages is one of the grooves.
[Item 9]
   The ignition coil according to item 8, wherein
      the number of the grooves is two, and
      the two grooves face each other.
[Item 10]
   The ignition coil according to item 8, wherein
      the number of the grooves is three, and
      the three grooves are arranged at regular intervals.
[Item 11]
   The ignition coil according to any one of items 1 to 10, wherein
      the cap includes a hole extending from the internal bottom surface to an upper surface of the cap, and
      one of the air passages is the hole.
[Item 12]
   The ignition coil according to item 11, wherein
      the hole has an opening located at a center of the internal bottom surface.
[Item 13]
   The ignition coil according to item 11 or 12, wherein
      the hole has an inner diameter of 0.5 to 2.0 mm.

### INDUSTRIAL APPLICABILITY

The ignition coil as described above is used in various internal combustion engines.

### REFERENCE SIGNS LIST

2 . . . ignition coil
4 . . . coil assembly
6 . . . connector portion
8 . . . output portion
10 . . . plug boot
12 . . . spring
14, 36 . . . case
16 . . . primary coil
18 . . . secondary coil
20 . . . iron core
22 . . . high-voltage terminal
24 . . . arm
26, 60, 80, 100, 120, 140, 150 . . . cap of high-voltage terminal
28, 62, 82, 102, 152 . . . resistor
29, 162 . . . upper surface of resistor
30 . . . tubular portion
32 . . . external terminal
34 . . . ignitor
42, 160 . . . depression
44, 122 . . . cavity
46, 130 . . . bottom surface
48 . . . opening
50, 64, 84, 104, 124, 142, 155 . . . inner circumferential surface of cap
52, 126, 146, 154 . . . internal bottom surface of cap
53, 66, 86, 106 . . . outer circumferential surface of resistor
54, 68, 88, 108 . . . contact point
55, 67, 87, 107 . . . gap (air passage)
56, 70, 90, 110 . . . contact side
58, 72, 92, 112 . . . non-contact side
128, 144 . . . groove (air passage)
156 . . . upper surface of cap
158 . . . hole

1. An ignition coil for an internal combustion engine, the ignition coil comprising:
a primary coil;
a secondary coil;
a resistor shaped as a rod; and
a high-voltage terminal electrically connecting an output of the secondary coil to the resistor, wherein
the high-voltage terminal includes a cap having an inner circumferential surface and an internal bottom surface and covering an end of the resistor, and
the ignition coil further comprises one or more air passages leading from the internal bottom surface to an external environment.

2. The ignition coil according to claim 1, wherein
an outer circumferential surface of the resistor and the inner circumferential surface are in contact at three to six points in a cross-section perpendicular to a direction in which the resistor extends and taken at a location where the resistor is covered by the cap, and
one of the air passages is a gap between the outer circumferential surface and the inner circumferential surface.

3. The ignition coil according to claim 2, wherein
in the cross-section, the outer circumferential surface of the resistor and the inner circumferential surface of the cap are in contact at three points.

4. The ignition coil according to claim 2, wherein
in the cross-section,
the inner circumferential surface includes a plurality of contact sides each of which is in contact with the resistor at a point and a plurality of non-contact sides that are not in contact with the resistor, and
each of the contact sides is located between two of the non-contact sides.

5. The ignition coil according to claim 4, wherein
each of the contact sides is longer than an adjacent one of the non-contact sides.

6. The ignition coil according to claim 5, wherein
each of the contact sides is 1.5 to 2.5 times longer than the adjacent one of the non-contact sides.

7. The ignition coil according to claim 2, wherein
in the cross-section, the inner circumferential surface of the cap is polygonal.

8. The ignition coil according to claim 1, wherein
the inner circumferential surface of the cap includes one or more grooves each of which has one end at the internal bottom surface, and
one of the air passages is one of the grooves.

9. The ignition coil according to claim 8, wherein
the number of the grooves is two, and
the two grooves face each other.

10. The ignition coil according to claim 8, wherein
the number of the grooves is three, and
the three grooves are arranged at regular intervals.

11. The ignition coil according to claim 1, wherein
the cap includes a hole extending from the internal bottom surface to an upper surface of the cap, and
one of the air passages is the hole.

12. The ignition coil according to claim 11, wherein
the hole has an opening located at a center of the internal bottom surface.

13. The ignition coil according to claim 11, wherein
the hole has an inner diameter of 0.5 to 2.0 mm.
